(19) United States
(12) Patent Application Publication
(10) Pub. No.: US 2004/0093354 A1
(43) Pub. Date: May 13, 2004

(54) Method and system of representing musical information in a digital representation for use in content-based multimedia information retrieval

(76) Inventors: Changsheng Xu, Singapore (SG); Yongwei Zhu, Singapore (SG)

Correspondence Address: KNOBBE MARTENS OLSON & BEAR LLP, 2040 MAIN STREET, FOURTEENTH FLOOR, IRVINE, CA, 92614, US

(21) Appl. No.: 10/670,083

(22) Filed: Sep. 23, 2003

Related U.S. Application Data
(63) Continuation of application No. PCT/SG01/00044, filed on Mar. 23, 2001.

(51) Int. Cl. G06F 7/00

(52) U.S. Cl. 707/104.1

(57) ABSTRACT

The invention relates to content-based audio/music retrieval and other content-based multimedia information retrieval. In one aspect the present invention provides a method of representing audio/musical information in a digital representation suitable for use in content-based information indexing and retrieval including the steps of: determining a first representation including a set of peaks and valley corresponding to maximum and minimum values respectively of at least one characteristic of the audio/music, and; determining a second representation including values representing relative differences between peaks and valleys. The invention presents a method and a system for content-based music retrieval. A music score database is constructed to provide a unique representation of real music songs. Score keywords are extracted from the music score as the features of the musing songs.

### RELATED APPLICATIONS

This application is a continuation application, and claims the benefit under 35 U.S.C. §§120 and 365 of PCT application No. PCT/SG01/00044 filed on Mar. 23, 2001 and published on Jan. 16, 2003, in English, which is hereby incorporated by reference herein.

### FIELD OF INVENTION

This invention relates to content-based audio/music retrieval and other content-based multimedia information retrieval where the multimedia information includes audio/music.

### BACKGROUND OF INVENTION

The rapid development of computer networks and the technologies related to Internet have resulted in a rapid increase of the size of digital multimedia data collections. How to effectively organize such information to allow efficient browsing, searching and retrieval has been an active research area in the past decades and still is. Various kinds of content-based image and video retrieval methods have been developed since the early 1990's. The accuracy and speed are two important index performances to evaluate a retrieval method. Compared with the content-based image and video retrieval, content-based audio retrieval, especially music retrieval, provides a special challenge because a raw digital audio data is a featureless collection of bytes with most rudimentary fields attached such as name, file format, sampling rate, which does not readily allow content-based retrieval. Current content-based audio retrieval methods followed the same ideas as with the content-based image retrieval. Firstly, a feature vector is constructed by extracting acoustic features of audio in the database. Secondly, the same features are extracted from the queries. Finally, the relevant audio in the database is ranked according to the feature matching between the query and the database.

U.S. Pat. No. 5,918,223 discloses a system that performs analysis and comparison of audio files based upon the content of the data files. The analysis of the audio data produces a set of numeric values (a feature vector) that can be used to classify and rank the similarity between individual audio files typically stored in a multimedia database or on the World Wide Web. The analysis also facilitates the description of user-defined classes of audio files, based on an analysis of a set of audio files that are members of a user-defined class. The system can find sounds within a longer sound, allowing an audio recording to be automatically segmented into a series of shorter audio segments.

The publication entitled “Content-based Classification and Retrieval of Audio Using the Nearest Feature Line Method” by Stan Z. Li (IEEE Transactions on Speech and Audio Processing, Accepted, 1999) discloses a method for content-based audio classification and retrieval. It is based on a new pattern classification method called the nearest Feature Line (NFL). In the NFL, information provided by multiple prototypes per class is explored. This contrasts to the nearest the nearest neighbor (NN) classification in which the query is compared to each prototype individually. Regarding audio representation, perceptual and cepstral features and their combinations are considered.

The publication entitled “Content-based Retrieval of Music and Audio” by J. Foot (Proc. of SPIE, Vol.3229, 1997, pp. 138-147) discloses a method to use 12 mel-frequency cepstral coefficients (MFCCs) plus energy as the audio features. A tree-structured vector quantizer is used to partition the feature vector space into a discrete number of regions or “bins”. Euclidean or Cosine distances between histograms of sounds are compared and the classification is done by using NN rule.

One problem with existing methods is that these are considered to fail to obtain a satisfactory retrieval accuracy rate because of the noise is introduced in the process of feature extraction. Furthermore, it is considered that prior art methods are time-consuming if the feature vector space becomes large.

### SUMMARY OF INVENTION

In one aspect the present invention provides a method of representing audio/musical information in a digital representation suitable for use in content-based information indexing and retrieval including the steps of: determining a first representation including a set of peaks and valleys corresponding to maximum and minimum values respectively of at least one characteristic of the audio/music, and; determining a second representation including values representing relative differences between peaks and valleys.

In another aspect the present invention provides a method of creating an audio/music score database, including the steps of: using an audio/music score to uniquely represent an actual music song such that there is a link provided between an audio/music score database and an audio/music database; using a curve including a set of digital values to represent the audio/music score, and; using peaks and valleys of the curve for indexing the audio/music score database.

In yet another aspect the present invention provides a method of converting an audio/music score into score keywords, including the steps of: pre-processing a score curve to remove zero notes, the score curve including a set of digital values representing audio/musical notes; detecting peaks and valleys of the score curve; calculating the distance between each peak/valley and valley/peak pair; using the peaks and valleys as reference points, and a note histogram of the peaks and valleys to serve as score keywords.

In still another aspect the present invention provides a system for use in content-based information retrieval operating in accordance with a method as described above.

In essence, the present invention stems from the: realisation that a representation of audio/musical information, which includes a characteristic relative difference value, provides a relatively accurate and speedy means of representing, indexing and/or retrieving content-based audio/musical information. It has also been found that these relative difference values provide a relatively non-complex feature representation.

In a preferred embodiment, the method of the present invention further includes the step of determining a histogram of the first representation.

Preferably, the histogram of the first representation includes a representation of, the population, or duration, of peaks or valleys in a given time interval.

Preferably, the relative difference value for a peak is given by the difference between the magnitude of a valley immediately following the peak and the magnitude of the peak, and, the relative difference value of a valley is given by the difference between the magnitude of a peak immediately following the valley and the magnitude of the valley.

In another preferred embodiment, the method of the present invention further includes the step of determining a histogram of the second representation.

Preferably, the audio/musical information is a music score. In this embodiment, the method of the present invention further includes the step of pre-processing the music score before performing the step of determining the first representation, which includes removing zero notes from the music score, and, adjoining the remaining nonzero notes to fill any gaps left by the removed zero notes.

Preferably, the audio/musical information is an acoustic signal and, the acoustic signal may be a vocal or humming signal. In this embodiment, the method of the present invention includes the step of pre-processing the acoustic signal before performing the step of determining the first representation, which includes converting the acoustic signal to a digital signal; removing noise from the digital signal; subjecting the noise free digital signal to pitch detection; and, subjecting the pitch detected digital signal to interval or note detection. The pitch detection includes a windowed Fourier transform and auto-correlation of the noise free digital signal. The interval or note detection includes logarithmically scaling the pitch detected digital signal.

Preferably, the characteristic of the audio/music is any one or more of the following: volume level; pitch; or interval information.

In another preferred embodiment the present invention provides a method of creating a music score database, including the steps of: representing an actual music track uniquely with a music score such that there is a link between the music score and the actual music track; representing the music score in accordance with a method as described above to form search keywords; and, storing the search keywords in a database.

In a preferred embodiment of the present invention, the method of creating a music score database further includes the step of creating at least one index for storage with the database, the at least one index including a global feature corresponding to an entire music score wherein the global feature includes the histogram of the second representation.

In another preferred embodiment the present invention provides a method of creating a query keyword from an acoustic input for retrieval of music information in a music score database including the step of representing the acoustic input in a digital representation in accordance with a method as described above.

In yet another preferred embodiment, the present invention provides a method of retrieving music information from a music score database created in accordance with the method of creating a music score database as described above by matching query keywords with database keywords including the steps of: comparing a query keyword, created in accordance with the method of creating a query keyword as described above, with the global feature corresponding to each music score to eliminate non-relevant database keywords; comparing the second representation of the query with the second representation of each database keyword; comparing the histogram of the first representation of the query with the histogram of the first representation of each database keyword.

In a preferred embodiment, the present invention provides a method of creating indexes to organise the music score database including the step of: constructing a global feature for the complete actual music song, wherein the global feature is the histogram of the values of the distances between each peak/valley and valley/peak pair.

In yet another preferred embodiment, the present invention provides a method of automatically converting acoustic input in the form of humming into query keywords, including the steps of: converting the acoustic input into a digital signal; detecting the pitch from the digital signal; converting the pitch into notes; representing the acoustic input by a pitch curve; smoothing of the pitch curve by removing small peaks and valleys; detecting peaks and valleys of the pitch curve; generating the query keywords using the peaks and valleys in accordance with the following steps:

calculating the distance between each peak/valley and valley/peak pair; and,

using the peaks and valleys as reference points, and a note histogram of the peaks and valleys to serve as score keywords.

In another preferred embodiment the present invention provides a method of matching the query keywords with the music score keywords, including the steps of: checking the global feature to eliminate non-relevant music score keywords; matching the sequence of peak/valley distance values of the query and the peak/alley distance values of the music score keywords; and, matching the note histogram by histogram intersection.

It is desirable to provide a content-based music retrieval method to improve the accuracy and speed of the retrieval which would overcome the problems associated with the prior art discussed. It is also desirable to provide a method to convert queries inputted by humming into query keywords to match keywords extracted from a music database. Still further it is desirable to provide an effective indexing method to organise the database and to provide a robust similarity matching method to match the query keywords with the database keywords.

Score Keywords Extraction and Database Construction

In order to improve the accuracy of content-based retrieval, database construction is very important. In the traditional content-based audio/music retrieval methods, the database is constructed by extracting the features from the audio/music clips and generating the feature vectors for each audio/music clip. Since the feature extraction is an approximate process and it is difficult to use several features to exactly represent the characteristics of all kinds of audio/music, the noise introduced in this process will definitely affect the accuracy of the retrieval results. In one embodiment, the present invention proposes a method of constructing the database. Unlike image and video, music songs are produced by composers, so each musical piece has a music score which can uniquely characterise the music. Based on this fact, we extract the score keyword from the music scores as the features of the real music songs. Compared with low-level features, a music score keyword is a more effective representation of the music. It is able to capture the most significant properties of the music and to dramatically reduce the noise in the database side for music retrieval.

Query Processing

In another embodiment of the present invention, we provide a query method that is different from the traditional text-based query method. The users can input their queries by humming a piece of music or song through a microphone. The inputted queries are automatically converted into query keywords by applying the method of the present invention to the queries. The extracted query keywords are matched with the score keywords in the database. The retrieval results are ranked according to the similarities between the query and score keywords.

Indexing and Matching

When performing a query-by-humming in a small music database, it is easy to compute the similarity measure for all the music songs in the database from the humming sound and then to choose the music songs that match the desired result. However, for large databases, this can be prohibitively expensive. In practical applications, a music database usually contains several thousands or even tens of thousands of songs. To make the content-based music retrieval truly scalable to large size music collections and to speed up the search, efficient indexing techniques need to be explored. In the present invention, we provide an effective indexing scheme to organise the database. This can achieve a high-speed search in a large database.

Another important factor that will affect the accuracy of the content-based music retrieval is the matching method. Since we cannot ensure that the users who input the queries are music experts, it is difficult for laymen to hum a song exactly, especially when humming from memory. Therefore, any keywords matching method applied to retrieving music by humming must tolerate the errors in the query side. In one embodiment of the present invention, in order to get higher retrieval accuracy Non-Euclidean similarity measures are used. This is based on the consideration that Euclidean measurement may not effectively simulate human perception of a certain auditory content. Non-Euclidean measures include Histogram Intersection, Cosine, and Correlation, etc. On the other hand, the indexing technique used in embodiments of the present invention is also capable of supporting Non-Euclidean similarity measures.

### BRIEF DESCRIPTIONS OF THE DRAWINGS

These and other features and advantages of the present invention will be readily apparent to one of ordinary skill in the art from the following written description, used in conjunction with the attached drawings, in which:

FIG. 1 illustrates the system structure of the communications between the server and the client in a music database retrieval system using the present invention.

FIG. 2 illustrates the structure of the music score database of FIG. 1.

FIG. 3 illustrates the block diagram of the score database construction.

FIG. 4 illustrates the score melody processing done in the score database construction.

FIG. 5 illustrates a flowchart of the score/pitch keyword extraction.

FIGS. 6(a) to (c) illustrate a piece of music score, the melody contour, and an example of the extracted score keywords.

FIG. 7 illustrates a flowchart of the query processing and keyword extraction.

FIG. 8 illustrates a flowchart of the pitch melody processing done in the query processing.

FIGS. 9(a) to (c) illustrate a digital query signal, the detected pitch and interval contour, and an example of the extracted score keywords.

FIGS. 10(a) to (c) illustrate another digital query signal, the detected pitch and interval contour, and an example of the extracted score keywords.

FIG. 11 illustrates a block diagram of a method of matching between the score keywords and the query keywords.

FIG. 12 illustrates a flowchart of the matching algorithm.

### DETAILED DESCRIPTION OF PREFERRED EMBODIMENTS

FIG. 1 illustrates the system structure of the communications between the client 22 and server 20. There are one or several music databases 24 at the server 20 to store digital music contents. There is a music score database 26 including the score keywords corresponding to each music database. The services in the server 20 side include receiving queries 28 from the clients, matching query keywords 30 with score keywords in the music score database 26, retrieving the relevant music songs and sending them to the clients 22. The services in the client side include music search engine 32, query processing 34, and music browsing 36. The user can input his or her humming to the music search engine through the microphone. The query-processing module 34, will extract the query keywords from the query and send the query keywords to the server 20 through the Internet 38. When the server sends back the retrieved music songs to the client 22, the music-browsing tool 36 will enable the user to view these songs clearly and listen to them easily.

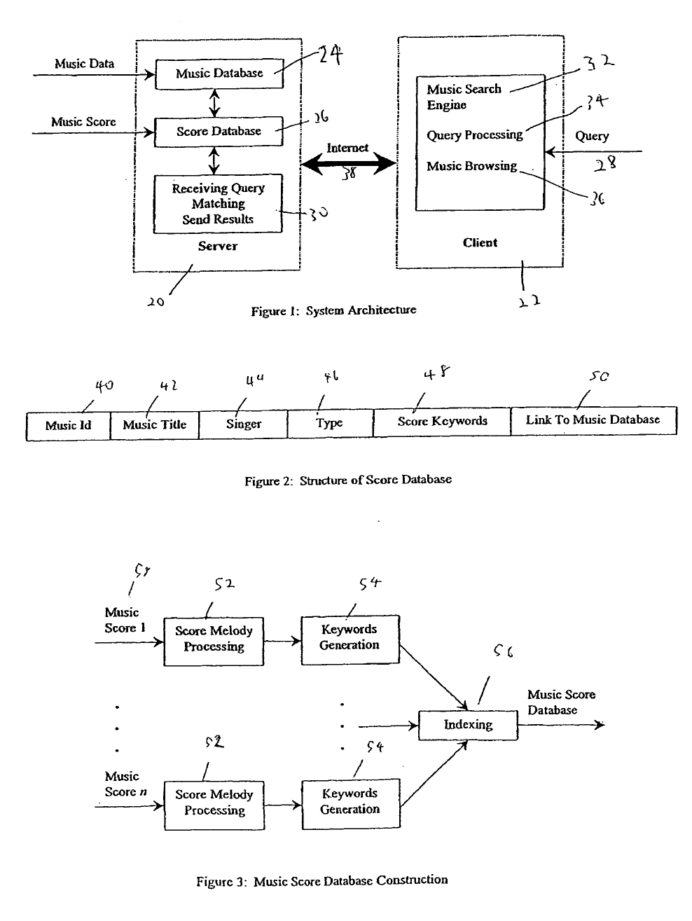

FIG. 2 illustrates the structure of the music score database. The music score database corresponds to the music database that includes the actual music songs. The fields of a record in the music score database include music ID 40, music title 42, singer 44, music type 46, score keywords 48, and a linkage to the actual music stored in the music database 50.

FIG. 3 illustrates a block diagram of score database construction. It consists of 3 steps: score melody processing, score keywords generation, and score keywords indexing.

The input to this module is the music score 58 corresponding to a music song, which may also be inserted into music database. The music score 58 provides the composite information of the music and is available once the musical artists create the music. The music score 58 basically specifies what note is played at what time for how long. Thus the music score 58 can be easily represented in digital form. We represent each note by an integer, and a larger integer corresponds to a higher note. The distance between two adjacent notes is semitone, and the distance between the two integers representing the two notes is also 1. The time information of each note is measured in an integer multiples of quarter-beat (or finer unit).

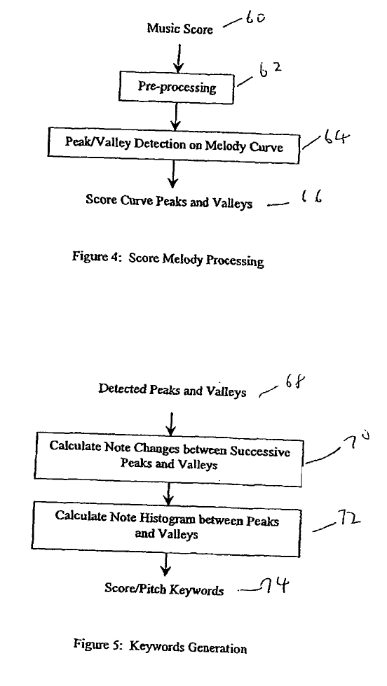

The music score information is processed by the score melody processing module 82 followed by keyword generation module 54. The two modules will be illustrated by individual figures. (FIG. 4 and FIG. 5). After the score keywords are extracted 54, they can be indexed 56 for the purpose of efficient storage and searching of the score database.

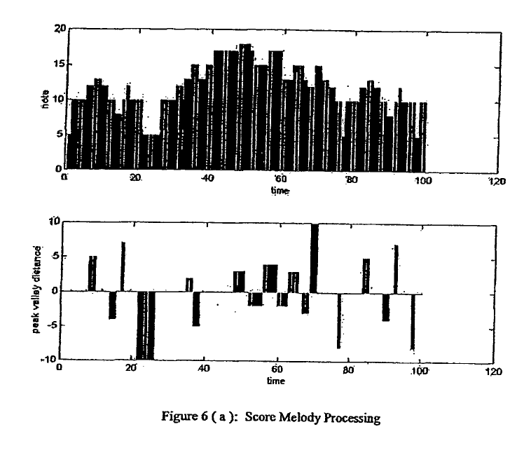

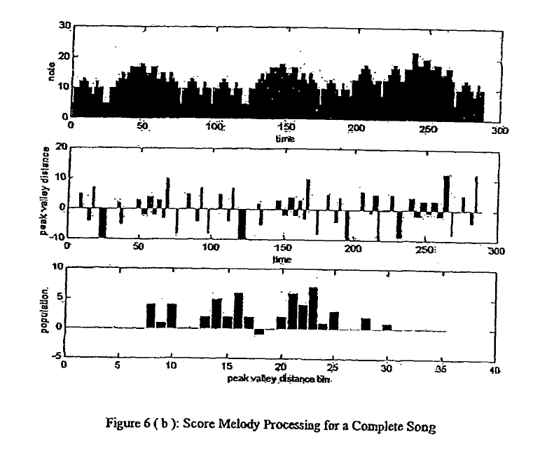

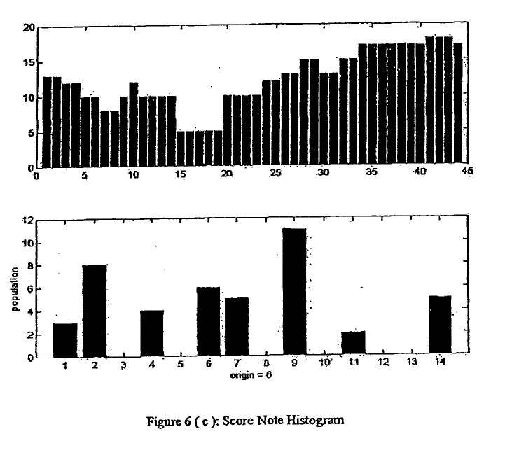

FIG. 4 illustrates the flowchart of the score melody processing module. Music scores 60 are firstly, in preprocessing 62, transformed into a curve with x-axis being time and y-axis being note levels. Since only relative note changes are important, the absolute value of each note is neglected. In music scores, there is a zero (0) note, which represents silence. The 0 notes are removed from the score curve, the notes ahead and behind the removed 0 note are simply connected. Secondly, the peaks and valleys of the score curve are detected 64. A peak is defined as a note being higher than both of the two notes connected to it ahead and behind. And similar is the definition of a valley. These peaks and valleys, are very important feature points used for the indexing and retrieval of the music 66. An example of score curve and its peaks and valleys are illustrated in FIG. 6(a).

FIG. 5 illustrates the flowchart of the score keywords generation. After the peaks and valleys of the score curve are detected, for each peak and each valley, a value is calculated 70. For a peak, the value is the difference between its immediate following valley and itself, and the value is positive. For a valley, the value is the difference between its immediate following peak and itself, and it is a negative value. The sequence of values of the peaks and valleys are the first part of the features used in music retrieval. The lower picture in FIG. 6(a) shows the peaks and valleys together with their associated values.

Then the note histogram 72 is calculated for each peak and valley. The note histogram contains information of how many or how long a note is presented during a time interval. The time interval can be a constant time duration or from the starting peak/valley to the x^{th} peak/valley that follow it. FIG. 6(c) shows the note histogram for the first peak in the example. We have in our example used the interval from a peak/valley to the 4^{th} valley/peak.

The feature values of the peaks and valleys of a complete song can also be statistically stored in a histogram and used as a global feature of the music 74. It can be used as the first step in the matching. If there is no match between the histogram and the searched music, then the further matching of other features is not necessary. This can speed up the searching process.

FIG. 6(a) is an example score curve corresponding to a piece of a music score. The detected peaks and valleys and their feature values are also shown. FIG. 6(b) is the detected peaks/valleys for the complete piece of music. The figure at the bottom shows the global feature, which is the histogram of the peak/valley feature values. FIG. 6(c) is the extracted score keywords corresponding to the first peak of the score curve. In this figure, the origin of the histogram is 6, which means the bin 6 corresponds to the note value of the starting note (first peak in this example).

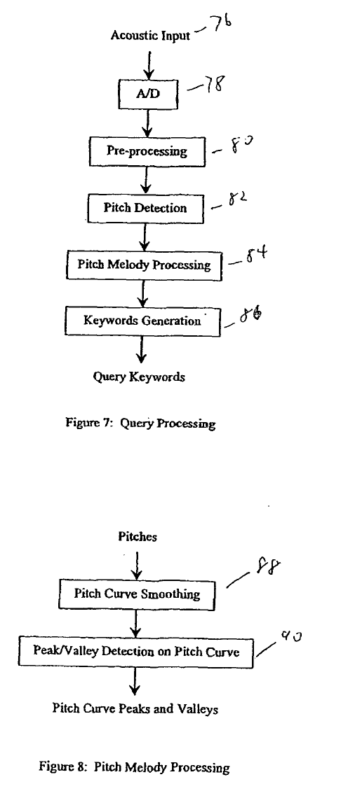

FIG. 7 illustrates a block diagram of query keywords extraction. The query inputted by humming is an acoustic signal 76. It is converted to a digital signal via the A/D conversion 78 device such as a sound card. The digital signal passes through a pre-processing 80 mechanism to remove the environment noise. Then pitch detection 82 and interval detection are applied to the processed digital signal. In order to get a smooth pitch and interval contour, a pitch melody processing 84 is conducted to the extracted pitch and interval information. Finally, the query keywords are generated 86 according to the pitch and interval contour.

The pitch detection is done by windowed Fourier transform and auto-correlation.

The interval detection or note detection by logarithmically scaling of the detected pitch values. After note detection, the temporal change in the note value is comparable to the temporal change in the score note value. The inputted humming query can then be represented in a pitch curve. Further feature 20 extraction can be done on this pitch curve.

The pitch melody processing detects the peak/valleys in the pitch curve, just as those for the score curve (FIG. 8).

The final query keyword generation is done using the same process as for score curve, which is shown in FIG. 5.

FIG. 8 illustrates the flowchart of the pitch melody processing. The pitch curve is smoothed 88 firstly by removing small value changes. Then peak/valley detection 90 is conducted on the smoothed pitch curve. Similar to the indexing process, or score keyword processing, the query keyword extraction also calculates the peak/valley values changes and the note histogram. These features are then used in the matching process.

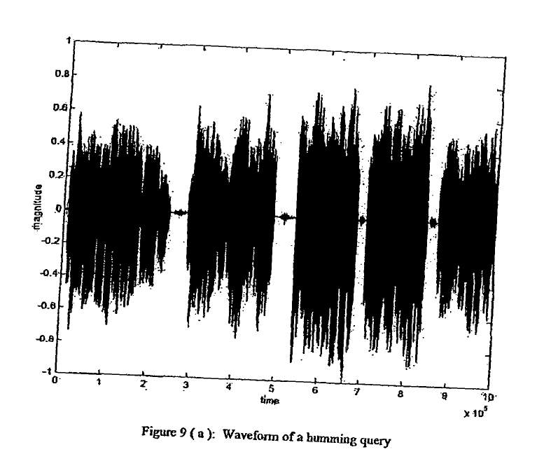

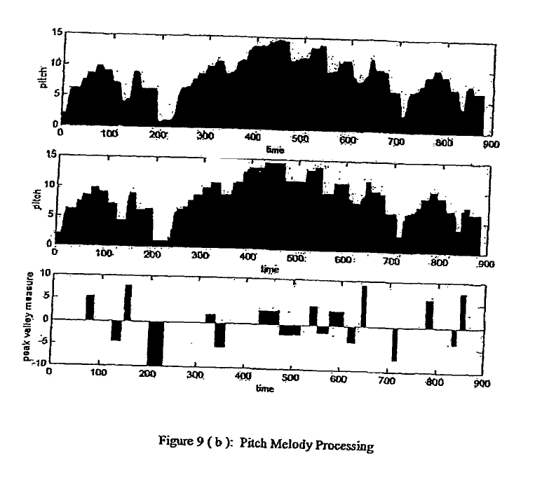

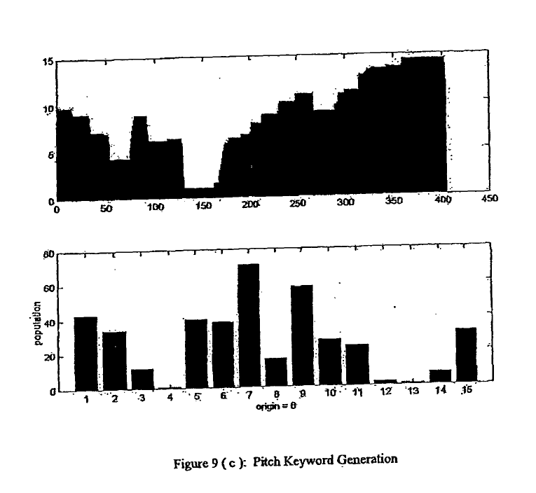

FIG. 9(a) is a digital query signal converted from humming the same as the piece of music score in FIG. 6(a). FIG. 9(b) is the detected pitch and interval contour from FIG. 9(a). The detected peak/valley values are also shown. FIG. 9(c) is the extracted pitch keywords according to the information of FIG. 9(b).

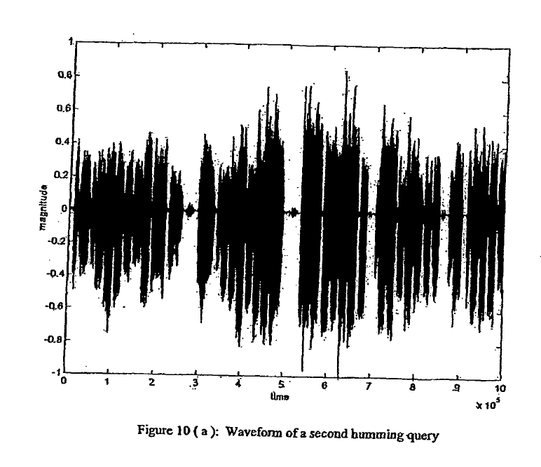

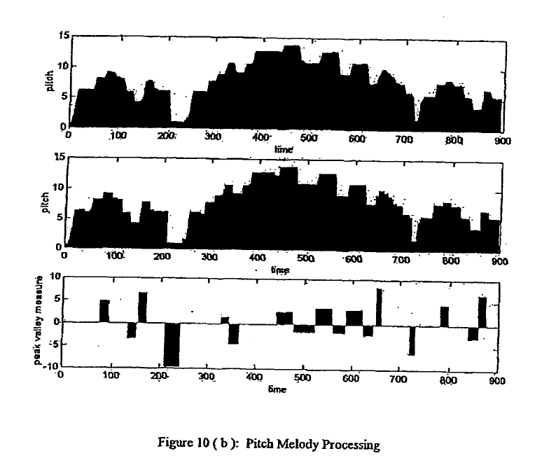

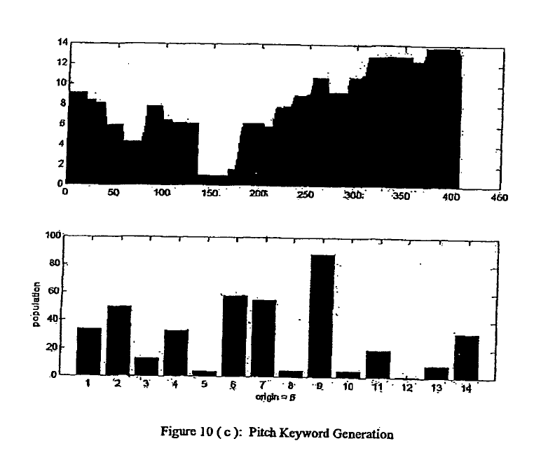

FIG. 10(a) is another digital query signal converted from humming the same as the piece of music score in FIG. 6(a). FIG. 10(b) is the detected pitch and interval contour from FIG. 10(a). The corresponding peak/valley values are also shown. FIG. 10(c) is the extracted score keywords according to the information of FIG. 10 (b). From FIG. 9, FIG. 10 and FIG. 6, it can be seen that either the score/pitch contours or the query keywords and the score keywords are similar.

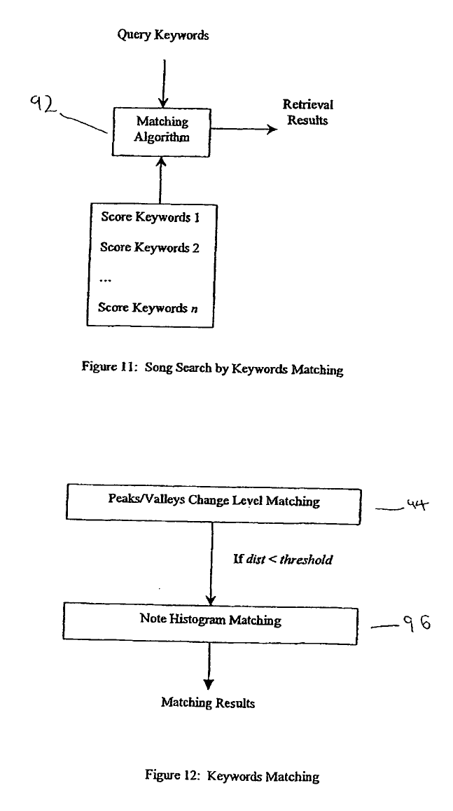

FIG. 11 illustrates the block diagram of matching between the score keywords and the query keywords. The extracted query keywords will be compared with the score keywords in the database by use of a matching algorithm 92. The retrieval results will be ranked according to the similarity between the query keywords and score keywords and fed back to the users.

FIG. 12 shows the steps in the keyword matching. In step 1, the detected peak/valley values from query are compared to those of the score keyword 94. The comparison is then by measuring the cumulated distance of the peak/valley values. If the distance is less than a threshold, further similarity measure is done; otherwise, the matching should skip to next candidate. The difference is measured for a sequence of peak/valley values, say 5 values, and the difference for the 5 values are summed to form the final distance, which is then compared with the threshold.

In step 2, the note histograms are compared 96. Histogram intersection can be used to measure the similarity between the query and the candidate. The similarity can be ranked to list the search result in an order from most similar to least similar.

1. A method of representing audio/musical information in a digital representation suitable for use in content-based information indexing and retrieval, the method comprising:
a) determining a first representation including a set of peaks and valleys corresponding to maximum and minimum values respectively of at least one characteristic of the audio/music; and
b) determining a second representation including values representing relative differences between the determined peaks and valleys.

2. A method as claimed in claim 1, further including:
c) determining a histogram of the first representation.

3. A method as claimed in claim 2, wherein the histogram of the first representation includes a representation of, the population, or duration, of peaks or valleys in a given time interval.

4. A method as claimed in claim 1, wherein the relative difference value for a peak is given by:
the difference between the magnitude of a valley immediately following the peak and the magnitude of the peak, and;
the relative difference value of a valley is given by:
the difference between the magnitude of a peak immediately following the valley and the magnitude of the valley.

5. A method as claimed in claim 1, further including:
d) determining a histogram of the second representation.

6. A method as claimed in claim 1, wherein the audio/musical information is a music score.

7. A method as claimed in claim 6, further including pre-processing the music score before performing a), wherein the pre-processing includes:
removing zero notes from the music score, and;
adjoining the remaining nonzero notes to fill any gaps left by the removed zero notes.

8. A method as claimed in claim 1, wherein the audio/musical information is an acoustic signal.

9. A method as claimed in claim 8, wherein the acoustic signal is a vocal or humming signal.

10. A method as claimed in claim 8, further including preprocessing the acoustic signal before performing a), wherein the pre-processing includes:
converting the acoustic signal to a digital signal;
removing noise from the digital signal;
subjecting the noise free digital signal to pitch detection; and
subjecting the pitch detected digital signal to interval or note detection.

11. A method as claimed in claim 10, wherein the pitch detection includes a windowed Fourier transform and auto-correlation of the noise free digital signal.

12. A method as claimed in claim 10, wherein the interval or note detection includes logarithmically scaling the pitch detected digital signal.

13. A method as claimed in claim 1, wherein the characteristic of the audio/music is any one or more of the following:
volume level;
pitch; and
interval information.

14. A method of creating a music score database, comprising:
representing an actual music track uniquely with a music score such that there is a link between the music score and the actual music track;
representing the music score in accordance with a representing method to form search keywords, wherein the representing method is adapted to represent audio/musical information in a digital representation suitable for use in content-based information indexing and retrieval, the representing method comprising: determining a first representation including a set of peaks and valleys corresponding to maximum and minimum values respectively of at least one characteristic of the audio/music; and determining a second representation including values representing relative differences between the determined peaks and valleys, whrein the audio/musical information is the music score; and
storing the search keywords in a database.

15. A method as claimed in claim 14, further including:
creating at least one index for storage with the database, the at least one index including a global feature corresponding to an entire music score wherein the global feature includes the histogram of the second representation.

16. A method of creating a query keyword from an acoustic input for retrieval of music information in a music score database, the method comprising:
representing the acoustic input in a digital representation in accordance with a representing method, wherein the representing method is adapted to represent audio/musical information in a digital representation suitable for use in content-based information indexing and retrieval,
wherein the representing method comprises:
determining a first representation including a set of peaks and valleys corresponding to maximum and minimum values respectively of at least one characteristic of the audio/music; and
determining a second representation including values representing relative differences between the determined peaks and valleys, whrein the audio/musical information is an acoustic signal.

17. A method of retrieving audio/music information from a music score database, by matching query keywords with database keywords, the method comprising:
a) comparing a query keyword, created from an acoustic input for retrieval of music information in a music score database, with a global feature corresponding to each music score to eliminate non-relevant database keywords;
b) comparing the second representation of the query with the second representation of each database keyword; and
c) comparing the histogram of the first representation of the query with the histogram of the first representation of each database keyword.

18. A method of creating a music score database, comprising:
a) using a music score to uniquely represent an actual music song such that there is a link provided between a music score database and a music database;
b) using a curve including a set of digital values to represent the music score information and;
c) using peaks and valleys of the curve so as to index the music score database.

19. A method of converting a music score into score keywords, comprising:
a) preprocessing a score curve so as to remove zero notes, the score curve including a set of digital values representing musical notes;
b) detecting peaks and valleys of the score curve;
c) calculating the distance between each peak/valley and valley/peak pair; and
d) using the peaks and valleys as reference points, and a note histogram of the peaks and valleys to serve as score keywords.

20. A method of creating indexes to organise a music score database created in accordance with a method, comprising:
constructing a global feature for the complete actual music song, wherein the global feature is the histogram of the values of the distances between each peak/valley and valley/peak pair,
wherein the music score database creating method comprises:
using a music score to uniquely represent an actual music song such that there is a link provided between a music score database and a music database;
using a curve including a set of digital values to represent the music score information and;
using peaks and valleys of the curve so as to index the music score database.

21. A method of automatically converting acoustic input in the form of humming into query keywords, comprising:
a) converting the acoustic input into digital signal;
b) detecting the pitch from the digital signal;
c) converting the pitch into notes;
d) representing the acoustic input by a pitch curve;
e) smoothing of the pitch curve by removing small peaks and valleys;
f) detecting peaks and valleys of the pitch curve; and
g) generating the query keywords using the peaks and valleys in accordance with a method, wherein the method comprises calculating the distance between each peak/valley and valley/peak pair; and using the peaks and valleys as reference points, and a note histogram of the peaks and valleys to serve as score keywords.

22. A method of matching query keywords with music score keywords, comprising:
a) checking a global feature for the complete actual music song, wherein the global feature is the histogram of the values of the distances between each peak/valley and valley/peak pair;
b) matching the sequence of peak/valley distance values of the query and the peak/valley distance values of the music score keywords; and
c) matching the note histogram by histogram intersection.

23. A system for representing audio/musical information in a digital representation suitable for use in content-based information indexing and retrieval, the system comprising:
means for determining a first representation including a set of peaks and valleys corresponding to maximum and minimum values respectively of at least one characteristic of the audio/music; and
means for determining a second representation including values representing relative differences between the determined peaks and valleys.

24. A system for creating a music score database, comprising:
means for using a music score to uniquely represent an actual music song such that there is a link provided between a music score database and a music database;
means for using a curve including a set of digital values to represent the music score information, and;
means for using peaks and valleys of the curve so as to index the music score database.

25. A system for converting a music score into score keywords, comprising:
means for preprocessing a score curve to remove zero notes, the score curve including a set of digital values representing musical notes;
means for detecting peaks and valleys of the score curve;
means for calculating the distance between each peak/valley and valley/peak pair; and
means for using the peaks and valleys as reference points, and a note histogram of the peaks and valleys to serve as score keywords.
